(19) United States
(12) Patent Application Publication
(10) Pub. No.: US 2020/0134678 A1
(43) Pub. Date: Apr. 30, 2020

(54) GLOBAL EXPERT REVIEWS METHOD

(71) Applicant: EMC IP HOLDING COMPANY LLC, Hopkinton, MA (US)

(72) Inventors: Diane B. Langston, Pleasant View, UT (US); Kyle A. Scarborough, Austin, TX (US); Noelle M. Boyle, Austin, TX (US)

(21) Appl. No.: 16/175,943

(22) Filed: Oct. 31, 2018

(51) Int. Cl. G06Q 30/02; G06Q 30/00

(52) U.S. Cl. CPC G06Q 30/0282; G06Q 30/018

(57) ABSTRACT

A method is used in providing governance for content by a content governance system in computing environments. A content licensing module obtains licensed content. The content licensing module comprises a financial module that analyzes finances for the licensed content. A content management module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. The content governance system comprises the content licensing module, the financial module, the content management module, the content repository, the content implementation module, and a quality control module.

### BACKGROUND

### Technical Field

This application relates to global expert reviews in computing environments.

### Description of Related Art

Companies often use third-party award logos and quotes on products, packaging, in marketing literature, and online.

### SUMMARY OF THE INVENTION

In accordance with one aspect of the invention is a method is used in providing governance for content by a content governance system in computing environments. A content licensing module obtains licensed content. The content licensing module comprises a financial module that analyzes finances for the licensed content. A content managing module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. The content governance system comprises the content licensing module, the financial module, the content management module, the content repository, the content implementation module, and a quality control module.

In accordance with one aspect of the invention is a system is used in providing governance for content by a content governance system in computing environments. A content licensing module obtains licensed content. The content licensing module comprises a financial module that analyzes finances for the licensed content. A content managing module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. The content governance system comprises the content licensing module, the financial module, the content management module, the content repository, the content implementation module, and a quality control module.

In accordance with another aspect of the invention, a computer program product comprising a computer readable medium is encoded with computer executable program code. The code enables execution across one or more processors for providing governance for content by a content governance system in computing environments. A content licensing module obtains licensed content. The content licensing module comprises a financial module that analyzes finances for the licensed content. A content managing module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. The content governance system comprises the content licensing module, the financial module, the content management module, the content repository, the content implementation module, and a quality control module.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 is a simplified illustration of a content governance module, in accordance with an embodiment of the present disclosure.

FIG. 2 is a high level illustration of a content governance system, in accordance with an embodiment of the present disclosure.

FIG. 3 is a block diagram of a computer, in accordance with an embodiment of the present disclosure.

FIG. 4 is a flow diagram illustrating processes that may be used in connection with techniques disclosed herein.

### DETAILED DESCRIPTION OF EMBODIMENT(S)

Described below is a technique for use in providing governance for content by a content governance system in computing environments, which technique may be used to provide, among other things, obtaining, by a content licensing module, licensed content, where the content licensing module comprises a financial module that analyzes finances for the licensed content, managing, by a content management module, allocation of the licensed content to prevent implementation of unlicensed content, where the licensed content is stored in a content repository, measuring, by a content implementation module, a performance associated with the implementation of the licensed content, and assessing, by the financial module, a value associated with the licensed content based on the performance, and providing the value to the content licensing module to determine maintenance of the licensed content in the content repository, where the content governance system comprises the content licensing module, the financial module, the content management module, the content repository, the content implementation module, and a quality control module.

Typically, companies showcase their products through press tours for visibility to industry media and analysts, and are seeded by public relations teams with industry experts for hands-on expert reviews. Respected third-party entities, such as industry experts, review and rate products and/or services produced by the companies. Industry publications (online and print) publish unbiased reviews of products/services, and distribute awards for products/services that impress, based on third-party entities' own criteria. This allows consumers and Business to Business (B2B) clients to make informed decisions regarding purchases, and enforces brand reputation. For example, a third-party entity may award a particular company with an award such as, “Company Named Best Product of the Year!” in “Third-Party Entity's Yearly Review of Best Products!”. These awards and/or industry expert reviews may be published by the third-party entity, along with logos associated with the third-party entity. In response, the company that is the recipient of the expert review and/or award may want to advertise this honor to their customers, for example, to boost their reputation in the industry, and/or maintain a positive brand reputation amongst industry experts. For example, a company may select the most positive expert review, and prestigious awards for their products published globally each week to pursue content licensing opportunities with third-party entities (i.e., publishers of the expert reviews and/or awards) for use of the content in the company's digital and print marketing and advertising efforts. Companies may publicize these awards by placing notification of the third-party award and associated quotes (such as “Company Named Best Product of the Year!”), along with logos associated with the third-party entity, on the company's printed materials, products, and/or web sites. The logos and quotes associated with the third-parties are the property of the third-party entity, and companies must receive permission from the third-party entities prior to using quotes and logos associated with the third-party entity. In other words, use of third-party award logos and quotes require licensing rights, publisher approvals, and adherence to usage requirements. Conventional technologies do not provide a method to prevent, for example, marketing teams, who may want to use awards logos and quotes, from using the awards logos and quotes without permission. Conventional technologies to not provide a method to prevent and/or mitigate the legal risk that occurs for example, when marketing teams use the awards logos and quotes without permission from the owners of the awards, quotes, and logos.

Obtaining permission to legally use logos and quotes (i.e., “licensed content”) may take weeks (or longer), and may encounter other challenges. For example, delays may occur during the completion of the content licensing and purchasing paperwork, a content license may be purchased that covers only one country (when the company may publish the quotes and logos in multiple countries), and/or the quotes and logos may be purchased at the third-party entity's list price, meaning the company's licensing team overpaid for the use of the quotes and logos. Conventional technologies do not provide a system that pro-actively obtains a pre-negotiated blanket content license that covers all marketing vehicles (i.e., published materials, product marking, websites, etc.). Conventional technologies do not track placement of licensed content, and do not track the documents required for legal and contract compliance.

By contrast, in at least some implementations in accordance with the current technique as described herein, a content governance system comprises a content licensing module, a financial module, the content management module, a content repository, a content implementation module, and a quality control module. The content licensing module obtains licensed content. The content licensing module comprises a financial module that analyzes finances for the licensed content. A content managing module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. Embodiments disclosed herein provide a system and method for the selection, procurement, and market uses in compliance with licensing of third-party expert review of, and awards for the company's product portfolio. Embodiment disclosed herein provide a centralized and streamlined global process that provides costs savings in licensing, as well as resource and bandwidth support. Embodiments disclosed herein provide a single source for supplier engagement (i.e., third party entities that provide expert reviews and awards), procurement, and finance.

Embodiments disclosed herein track all placements of licensed content and the documents required for legal and contract compliance. Embodiments disclosed herein rapidly publish award notification to a company's product pages, for example, within 72 hours of winning the award. Embodiments disclosed herein provide rapid access to expert reviews and awards, within a scalable system. Embodiments disclosed herein support request from, for example, marketing for use in all types of placements.

Thus, the goal of the current technique is to provide a single, unified and streamlined process for managing expert reviews and awards across a company, while maintaining a consistent high standard of content and compliance.

In at least some implementations in accordance with the current technique described herein, the use of providing governance for content by a content governance system in computing environments can provide one or more of the following advantages: preventing companies from using third party content without permission, providing a repository of licensed content for companies to use in multiple marketing vehicles and in multiple locations, providing guidance for appropriate pricing for licensed content, providing a centralized and streamlined global process that provides costs savings in licensing, as well as resource and bandwidth support, providing a single source for supplier engagement (i.e., third party entities that provide expert reviews and awards), procurement, and finance, providing rapid access to expert reviews and awards, within a scalable system, and providing a single, unified and streamlined process for managing expert reviews and awards across a company, while maintaining a consistent high standard of content and compliance.

In contrast to conventional technologies, in at least some implementations in accordance with the current technique as described herein, a method manages content searches in computing environments. A content licensing module obtains licensed content. The content licensing module comprises a financial module that analyzes finances for the licensed content. A content managing module manages allocation of the licensed content to prevent implementation of unlicensed content. The licensed content is stored in a content repository. A content implementation module measures a performance associated with the implementation of the licensed content. The financial module assesses a value associated with the licensed content based on the performance, and provides the value to the content licensing module to determine maintenance of the licensed content in the content repository. The content governance system comprises the content licensing module, the financial module, the content management module, the content repository, the content implementation module, and a quality control module.

In an example embodiment of the current technique, the content implementation module manages implementation of the licensed content to assure adherence to licensed content guidelines defined in the content licensing module. The quality control module accessing the content repository monitors the implementation of the licensed content.

In an example embodiment of the current technique, the content implementation module stores information associated with the implementation in the content repository.

In an example embodiment of the current technique, the quality control module accessing the content repository determines that the licensed content has an impending expiring license, and directs that the licensed content be removed from the implementation.

In an example embodiment of the current technique, the content licensing module obtains permission to use content that will be created in the future.

In an example embodiment of the current technique, the content management module receives a request from a user to implement content, and validates that the content associated with the request is licensed content.

In an example embodiment of the current technique, the content management module notifies the user of a license expiration date associated with the licensed content.

In an example embodiment of the current technique, the content management module notifies a plurality of users of at least a subset of the licensed content in the content repository.

In an example embodiment of the current technique, the content management module identifies at least one web content to update with the licensed content.

In an example embodiment of the current technique, the content management module identifies a plurality of licensed content from the content repository with which to update at least one web content.

In an example embodiment of the current technique, the content management module provides proposed guidelines for maintaining the licensed content in the content repository.

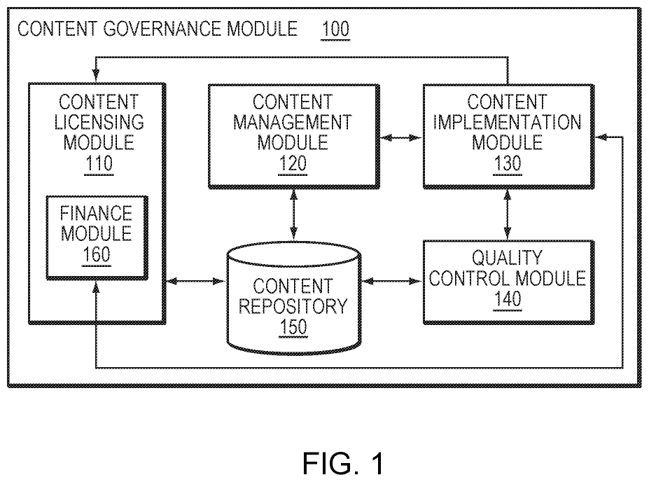

Referring now to FIG. 1, which provides a simplified illustration of a content governance system comprising a governance module 100, in accordance with an embodiment of the present disclosure. The content governance module 100 comprises a content licensing module 110, a financial module 160, the content management module 120, a content repository 150, a content implementation module 130, and a quality control module 140. In an example embodiment, the content licensing module 110 obtains licensed content, where the content licensing module 110 comprises the financial module 160 that analyzes finances for the licensed content. The content management module 120 manages allocation of the licensed content to prevent implementation of unlicensed content. The licensed content is stored in the content repository 150. In an example embodiment, the content repository 150 contains both licensed and unlicensed content. The content implementation module 130 measures a performance associated with the implementation of the licensed content. The finance module 160 assesses a value associated with the licensed content based on the performance, and provides the value to the content licensing module 110 to determine maintenance of the licensed content in the content repository 150. In an example embodiment, the content implementation module 130 manages implementation of the licensed content to assure adherence to licensed content guidelines defined in the content licensing module 110. The quality control module 140 that accesses the content repository 150, monitors the implementation of the licensed content.

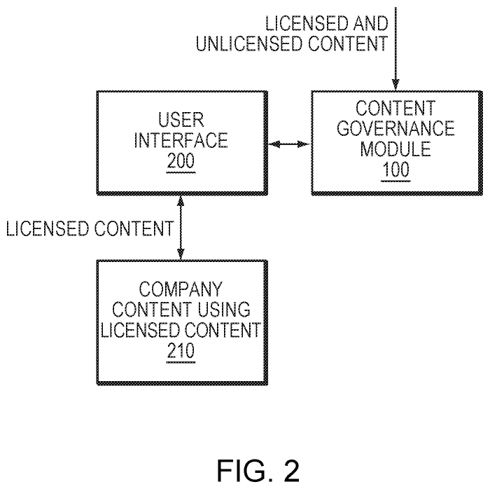

FIG. 2 is a high level illustration of a content governance system, in accordance with an embodiment of the present disclosure. In an example embodiment, a user, accessing a user interface 200, submits a request intake form to obtain licensed content for use in company content. The content governance module 100 validates the user's request, and provides the licensed content that is appropriate for the user. The licensed content is then implemented as company content using licensed content 210. Once the licensed content is implemented as company content, the content governance module 100 keeps track of the usage of the licensed content, and, for example, notifies the user of any impending expiration dates associated with the licensed content.

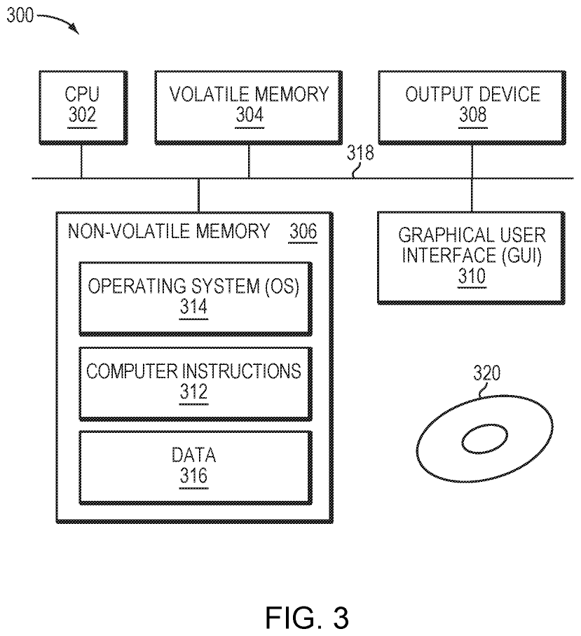

FIG. 3 illustrates a block diagram of a computer 300 that can perform at least part of the processing described herein, according to one embodiment. The computer 300 may include a processor 302, a volatile memory 304, a non-volatile memory 306 (e.g., hard disk), an output device 308 and a graphical user interface (GUI) 310 (e.g., a mouse, a keyboard, a display, for example), each of which is coupled together by a bus 318. The non-volatile memory 306 may be configured to store computer instructions 312, an operating system 314, and data 316. In one example, the computer instructions 312 are executed by the processor 302 out of volatile memory 304. In one embodiment, an article 320 comprises non-transitory computer-readable instructions. In some embodiments, the computer 300 corresponds to a virtual machine (VM). In other embodiments, the computer 300 corresponds to a physical computer.

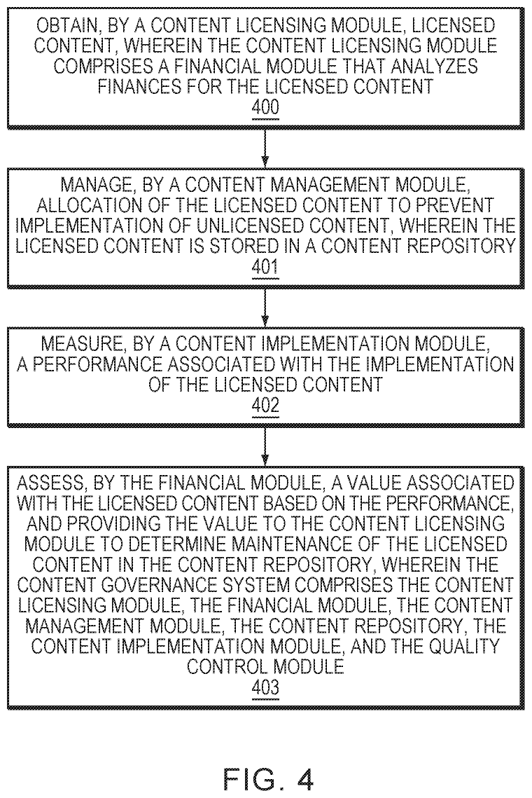

Referring to FIG. 4, shown is a more detailed flow diagram illustrating governance for content by a content governance system in computing environments. The content governance module 100 comprises the content licensing module 110, the financial module 160, the content repository 150, the content implementation module 130, and a quality control module 140. With reference also to FIGS. 1-3, the content licensing module 110 obtains licensed content (Step 400). In an example embodiment, a content selection and/or curation process adds all content (licensed or unlicensed) that meets an established criteria in the content repository 150. For example, the established criteria may set a threshold that the third-party entity award and/or expert review must meet a rating of 80% or higher, meaning an expert review that rates the company's product in the “top 75%” would not meet the established criteria. Another example of an established criteria may be, for example, plentiful positive “pull quotes” from published content, such as a third-party entity published article. Yet another example may be that the third-party entity award and/or expert review contain no advantageous competitor claims. In an example embodiment, a list of available expert reviews and/or awards content (i.e., licensed content), is maintained for companywide viewing to aid in the selection of material for product messaging and marketing campaigns. The content repository 150 is a centrally maintained global repository of licensed expert reviews and/or awards. Thus, users (such as business stakeholders) save time by easily searching for available expert reviews and/or awards using a self-service tool.

In an example embodiment, the content repository 150 comprises a plurality of relational data connections. For example, the content repository 150 maintains supplier profiles (i.e., profiles associated with the third party entities) that may contain, for example, contact information, invoices, receipts, permission emails (i.e., an email sent to a third party entity requesting permission to use expert reviews and/or awards information), contracts, logo images, etc. In an example embodiment, the content repository 150 maintains expert reviews that are published by the third party entities, usage rights to the content, usage guidelines, and expiration date associated with the content usage. In an example embodiment, the content repository 150 also maintains any grace periods associated with the licensed content, where the license may be used after the expiration date, during the grace period. In an example embodiment, the content repository 150 maintains copy tasks that are a record of pre-approved “pull quotes” from the expert reviews. In an example embodiment, the content repository 150 maintains merchandizing tasks that record the specific implementations of each review across the company globally. In an example embodiment, the content repository 150 contains both licensed and unlicensed content. In other words, the content repository 150 contains content for which licenses have been obtained, and content for which licenses have not been obtained. For example, the unlicensed content may not yet have a license because the license is being negotiated. Or, the unlicensed content may be in the process of being evaluated to determine if a license should be obtained for the unlicensed content. It may be determined that a license should not be obtained for the unlicensed content, and that unlicensed content would not be available for implementation for a user.

In an example embodiment, a supplier related data hierarchy is maintained within the content repository 150 for governance and compliance purposes, and to eliminate the risk of legal liability with licensors (such as the third-party entities). In an example embodiment, the content repository 150 is maintained to reflect accurate usage rights and updated status of contract terms associated with the licensed content. For example, contract terms and usage rights may include, but are not limited to contract expiration dates, permissible marketing vehicles (i.e., across print and digital marketing and advertising), and/or permitted global reach (including translation of content). In an example embodiment, all instances of marketing uses of licensed content are recorded according to the data hierarchy to maintain compliance, and to adhere to contract terms associated with the licenses. The data in the content repository 150 is kept current and accurate to adhere to quality standards, contractual obligations, and legal guidelines. Instances of marketing uses may include but are not limited to website merchandizing, social media amplification, email, email marketing and Direct mail marketing, catalogs/brochures, sales presentation, and/or advertisement placements/paid search. Instances of marketing uses may include all types of marketing placements, online (including both paid and organic search engine results) and offline.

In an example embodiment, annual blanket licensing agreements are obtained for the licensed content. The annual blanket licensing agreements allow the company to contract a broad license agreement with suppliers (such as third-party entities) for the use of licensed content, according to the contract terms in the annual blanket licensing agreements. For example, the blanket license may allow for use of any expert review provided by the licensor, use of the expert review in any global location, published in any vehicle, etc. The blanket license may also include the right to translate quotes, use videos, etc. Procurement of the annual blanket licensing agreements expedites the time to publish licensed content with proactive quality control. This enables global, “around-the-clock support” for operations.

The content licensing module 110 comprises the financial module 160 that analyzes finances for the licensed content. In an example embodiment, the content repository 150 maintains information associated with the budgeting and procurement of the licensed content. In an example embodiment, the content licensing module 110 obtains permission to use content that will be created in the future. For example, the use of annual blanket licensing agreements allow the company to proactively pre-pay for licensed content prior to the creation and/or publication of the licensed content. This provides a cost savings for the company.

In an example embodiment, the content management module 120 manages the allocation of the licensed content to prevent implementation of unlicensed content, where the licensed content is stored in the content repository 150 (Step 401). In an example embodiment, the content repository 150 may also comprise information regarding procurement of the license for the content. For example, the license may be obtained royalty free through an email requesting permission to use the content. The license may be obtained through an ad-hoc/single purchase licensing agreement. The license may be obtained through an annual blanket licensing agreement. In an example embodiment, company personal who wish to use the licensed content (i.e., “users”), may access the content repository 150. The contents of the content repository 150 may be filtered to provide relevant data of content (i.e., licensed content, licensed agreements, etc.) and shared with the users. The contents of the content repository 150 is shared with the users increase awareness of the content governance system, increase the ROI through marketing uses of the licensed content, and/or share marketing expertise. For example, a newsletter may be distributed to the users, to inform the users of available licensed content or, for example, the latest available licensed content. The information regarding the licensed content and the users to whom the newsletter should be distributed may be maintained within the content repository 150. The content repository 150 may also be “self-serve” where users search the content repository 150 for licensed content for example, for planning or marketing uses. For example, a user searching the content repository 150 would have access to a list of available expert reviews and awards (i.e., licensed content) that is maintained for companywide viewing to aid in the selection of material for product messaging and marketing campaigns. The user may search according to a particular company product, etc. The user may search for licensed content used by other, similar products, etc. Thus, stakeholder engagement of the users is maintained by providing access to the information within the content repository 150.

In an example embodiment, the licensed content from the content repository 150 is used to form a standard merchandizing customer experience that is displayed through a custom user (i.e., customer) interface developed for web pages on the company website. Thus, embodiments disclosed herein provide an intuitive consistent user (i.e., customer) experience across the company's published materials (i.e., printed and/or online) where the content of the company's published materials assist the customer in making purchasing decisions. For example, the licensed content is published on company owned websites, using, for example, independent web publishing platform(s). The standard merchandizing user experience is also published on the company's social media properties. Licensed content from the content repository 150 is also used as metadata for the company web pages to boost organic search rankings.

In an example embodiment, the content repository 150 receives a request from a user to implement content. In an example embodiment, a request intake process allows users to submit use cases for marketing uses of the licensed content, and facilitate final approvals of the licensed content (for example, for compliance with contract terms on all instances of marketing uses of licensed content produced by the users). In an example embodiment, the request intake process also notifies the requesting user of any future license expiration dates so that the user can take that information into account when implementing the expert review and/or award information within company materials. An internal request intake form and operational workflow tool is maintained to service and govern marketing/sales requests for all intended users of licensed content for promotional and advertising of the company's products that are related to the licensed content. In an example embodiment, any intended use of licensed content is recorded and tracked. Thus, there is dedicated assistance in the development of marketing materials. Embodiments disclosed herein provide internal operations processes and tools to assure legal compliance in the creation of marketing materials utilizing licensed publisher (i.e., third party entity) assets. There is also a single source of contact for content governance and publisher approvals. In an example embodiment, a user may also submit a request intake to seek subject matter expertise.

In an example embodiment, the content management module 120 validates that the content associated with the request is licensed content. In an example embodiment, the content management module 120 notifies the user of a license expiration date associated with the licensed content. In an example embodiment, the content management module 120 notifies a plurality of users of at least a subset of the licensed content in the content repository. For example, through the use of a newsletter, the content management module 120 may broadcast available licensed content to a group of users, and/or may target particular users for selected licensed content that the content management module 120 determines is relevant to that group of users. In an example embodiment, the content management module 120 identifies at least one web content to update with the licensed content. For example, the content management module 120 may identify web pages that would be enhanced with licensed content from the content repository 150. In an example embodiment, the standard merchandizing of expert reviews and awards on the company website uses a third party entity logo, or award image, a “pull quote” from the article, and a headline that hyperlinks back to the original content on the publisher's (i.e., third party entity) website. For example, embodiments disclosed herein may provide a “carousel” of expert reviews and awards that scroll across company web pages. The content management module 120 may also identify web pages that would be enhanced based on other web pages that benefited from updated licensed content. In an example embodiment, information regarding the other web pages that benefited may be determined by a performance measurement that is determined by the content implementation module 130. In another example embodiment, the content management module 120 may identify a plurality of licensed content from the content repository with which to update at least one web content. For example, an internal operations/workflow tool is used for the publishing of licensed content on corresponding products details web pages, for example, in the “browse” path of the company's website. The internal operations/workflow tool is also used to tract the content lifecycle. Thus, the content management module 120 may identify content, such as web pages, that may be enhanced by the addition of licensed content, and may also identify the licensed content from the content repository 150 with which to update the identified web pages.

In an example embodiment, the content implementation module 130 measures a performance associated with the implementation of the licensed content (Step 402). For example, the content implementation module 130 may determine that a company product has received a boost in sales, or a boost in reputation, due to the use of the third party entity's expert review and/or award. In an example embodiment, the performance may be a value associated with the licensed content.

In an example embodiment, the financial module 160 assesses a value associated with the licensed content based on the performance, and provides the value to the content licensing module to determine maintenance of the licensed content in the content repository 150 (Step 403). In an example embodiment, a value analysis method calculates a value, such as a cost saving value of the licensed content, for example, based on a comparative average units costs among the suppliers (such as the third-party entities) obtained from the content repository 150, and, for example, also from any associated cost savings from standard rate card pricing. For example, the value analysis method may determine that the price paid for licensing the content resulted in a positive calculated value. Alternatively, the value analysis method may determine that an adequate calculated value was not realized based on the cost of licensing the content. In another example embodiment, the financial module 160 may compare the calculated value of one licensed content with the calculated value of other licensed content to perform a comparison and utilize that information when negotiating various licenses. Embodiments disclosed herein compare at least one license to a previous cost of one or more licenses to determine which license is appropriate for a particular third party entity. Embodiments disclosed herein compare the license costs among third party entities to determine negotiation strategies for negotiation of future content licenses.

In an example embodiment, the content management module 120 determines maintenance of the licensed content in the content repository by providing proposed guidelines for maintaining the licensed content in the content repository. In other words, the content management module 120 may determine that the calculated value for licensed content did not meet a minimum threshold, and may provide proposed guidelines to use during the re-negotiation of the licensed content.

In an example embodiment, the content implementation module 130 manages implementation of the licensed content to assure adherence to licensed content guidelines defined in the content licensing module. For example, all instances of marketing uses of licensed content are recorded in the content repository 150 to maintain compliance, and to adhere to contract terms associated with the licenses. In an example embodiment, the content implementation module 130 stores information associated with the implementation in the content repository. The data in the content repository 150 is kept current and accurate to adhere to quality standards, contractual obligations, and legal guidelines. For example, users of the licensed content are notified if licensed content that has been published within company materials has an impending expiration date.

In an example embodiment, the quality control module 140 accessing the content repository 150 monitors the implementation of the licensed content. In an example embodiment, the content repository 150, the contents of the content repository 150, such as the licensed content, the content library, the documents associated with the licensed content, and the merchandized uses of the licensed content are scrutinized through real-time quality checks, and ongoing monthly and quarterly audits. Quality audit processes are adhered to, to maintain the best customer experience and to abide by legal guidelines agreed upon between the company and the content licensors (i.e., the third-party entities that publish the expert reviews and awards). This provides a better customer experience for all parties involved.

In an example embodiment, the quality control module 140 determines that the licensed content has an impending expiring license, and directs that the licensed content be removed from the implementation. In other words, a user is notified of the impending expiration of the licensed content, and is instructed to, for example, remove the licensed content from the company website by a specified date. In an example embodiment, any licensed content that is expired is removed from the content repository 150. In an example embodiment, the content repository 150 provides licensed content that may be substituted for the soon to be expiring licensed content. Use of unlicensed content may cause greater problems than just issues related to legal compliance. Third party entity content (such as expert reviews and/or awards information) that is, for example, left on a web page past the license expiration date requires the company to negotiate use of the licensed content after the fact, and this puts the company at a disadvantage during license negotiations, especially since the company may want to use the licensor's (i.e., the third party entity) content in the future, and may want to maintain a good working relationship with the licensor. Thus, embodiments disclosed herein provide an early incident and detection process that provides proactive resolution.

There are several advantages to embodiments disclosed herein. For example, the method improves the user's experience in accessing and implementing licensed content. The method increases ROI for stakeholders of the company. The method drives revenues for the company while maintaining compliance, for example, by adhering to contract terms. The method prevents companies from using third party content without permission. The method provides a repository of licensed content for companies to use in multiple marketing vehicles and in multiple locations. The method provides guidance for appropriate pricing for licensed content. The method provides a centralized and streamlined global process that provides costs savings in licensing, as well as resource and bandwidth support. The method provides a single source for supplier engagement (i.e., third party entities that provide expert reviews and awards), procurement, and finance. The method provides rapid access to expert reviews and awards, within a scalable system. The method enables global, “around-the-clock support” for operations. The method provides a single, unified and streamlined process for managing expert reviews and awards across a company, while maintaining a consistent high standard of content and compliance.

It should again be emphasized that the technique implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the FIGs illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method of providing governance for content by a content governance system, the method comprising:
obtaining, by a content licensing module, licensed content, wherein the content licensing module comprises a financial module that analyzes finances for the licensed content;
managing, by a content management module, allocation of the licensed content to prevent implementation of unlicensed content, wherein the licensed content is stored in a content repository;
measuring, by a content implementation module, a performance associated with the implementation of the licensed content; and
assessing, by the financial module, a value associated with the licensed content based on the performance, and providing the value to the content licensing module to determine maintenance of the licensed content in the content repository, wherein the content governance system comprises the content licensing module, the financial module, the content management module, the content repository, the content implementation module, and a quality control module.

2. The method of claim 1, further comprising:
managing, by the content implementation module, implementation of the licensed content to assure adherence to licensed content guidelines defined in the content licensing module; and
monitoring, by the quality control module accessing the content repository, the implementation of the licensed content.

3. The method of claim 2, wherein managing, by the content implementation module, implementation of the licensed content comprising:
storing information associated with the implementation in the content repository.

4. The method of claim 2, wherein monitoring, by the quality control module accessing the content repository comprises:
determining that the licensed content has an impending expiring license; and
directing that the licensed content be removed from the implementation.

5. The method of claim 1, wherein obtaining, by the content licensing module, licensed content comprises:
obtaining permission to use content that will be created in the future.

6. The method of claim 1, wherein managing, by the content management module comprises:
receiving a request from a user to implement content; and
validating that the content associated with the request is licensed content.

7. The method of claim 6, further comprising:
notifying the user of a license expiration date associated with the licensed content.

8. The method of claim 1, wherein managing, by the content management module comprises:
notifying a plurality of users of at least a subset of the licensed content in the content repository.

9. The method of claim 1, wherein managing, by the content management module comprises:
identifying at least one web content to update with the licensed content.

10. The method of claim 9, further comprising:
identifying a plurality of licensed content from the content repository with which to update the at least one web content.

11. The method of claim 1, wherein determining maintenance of the licensed content in the content repository comprises:
providing proposed guidelines for maintaining the licensed content in the content repository.

12. A system for use in providing governance for content by a content governance system, the system comprising a processor configured to:
obtain, by a content licensing module, licensed content, wherein the content licensing module comprises a financial module that analyzes finances for the licensed content;
manage, by a content management module, allocation of the licensed content to prevent implementation of unlicensed content, wherein the licensed content is stored in a content repository;
measure, by a content implementation module, a performance associated with the implementation of the licensed content; and
assess, by the financial module, a value associated with the licensed content based on the performance, and provide the value to the content licensing module to determine maintenance of the licensed content in the content repository, wherein the content governance system comprises the content licensing module, the financial module, the content management module, the content repository, the content implementation module, and a quality control module.

13. The system of claim 12, further configured to:
manage, by the content implementation module, implementation of the licensed content to assure adherence to licensed content guidelines defined in the content licensing module; and
monitor, by the quality control module accessing the content repository, the implementation of the licensed content.

14. The system of claim 13, wherein the processor configured to manage, by the content implementation module, implementation of the licensed content is further configured to:
store information associated with the implementation in the content repository.

15. The system of claim 13, wherein the processor configured to monitor, by the quality control module accessing the content repository, is further configured to:
determine that the licensed content has an impending expiring license; and
direct that the licensed content be removed from the implementation.

16. The system of claim 12, wherein the processor configured to obtain, by the content licensing module, licensed content is further configured to:
obtain permission to use content that will be created in the future.

17. The system of claim 12, wherein the processor configured to manage, by the content management module is further configured to:
receive a request from a user to implement content;
validate that the content associated with the request is licensed content; and
notify the user of a license expiration date associated with the licensed content.

18. The system of claim 12, wherein the processor configured to manage, by the content management module is further configured to:
notify a plurality of users of at least a subset of the licensed content in the content repository.

19. A computer program product for providing governance for content by a content governance system, the computer program product comprising:
a computer readable storage medium having computer executable program code embodied therewith, the program code executable by a computer processor to:
obtain, by a content licensing module, licensed content, wherein the content licensing module comprises a financial module that analyzes finances for the licensed content;
manage, by a content management module, allocation of the licensed content to prevent implementation of unlicensed content, wherein the licensed content is stored in a content repository;
measure, by a content implementation module, a performance associated with the implementation of the licensed content; and
assess, by the financial module, a value associated with the licensed content based on the performance, and provide the value to the content licensing module to determine maintenance of the licensed content in the content repository, wherein the content governance system comprises the content licensing module, the financial module, the content management module, the content repository, the content implementation module, and a quality control module.

20. The computer program product of claim 19, wherein the program code is further configured to:
manage, by the content implementation module, implementation of the licensed content to assure adherence to licensed content guidelines defined in the content licensing module; and
monitor, by the quality control module accessing the content repository, the implementation of the licensed content.
